(19) United States
(12) Patent Application Publication
(10) Pub. No.: US 2005/0278386 A1
(43) Pub. Date: Dec. 15, 2005

(54) Geospatial information system and method for updating same

(75) Inventors: Richard A. Kelly, West Lebanon, NH (US); Clayton R. Morlock, Lebanon, NH (US)

Correspondence Address: NIXON PEABODY, LLP, 401 9TH STREET, NW, SUITE 900, WASHINGTON, DC, 20004-2128, US

(73) Assignee: Geographic Data Technology, Inc., Lebanon, NH (US)

(21) Appl. No.: 10/866,770

(22) Filed: Jun. 15, 2004

(51) Int. Cl. G06F 7/00

(52) U.S. Cl. 707/200

(57) ABSTRACT

A geospatial information system is provided including a database, a processing unit adapted to access and retrieve the geospatial information from the database, a tool permissions module, a user interface module, a monitoring module, an audit module, a workflow management module, and an update module. Also, a method for updating geospatial information is provided including the steps of providing a database, accessing the database to retrieve geospatial information, associating a tool permission level to a user, generating a customized interface including a plurality of enhancement tools to request a change to the geospatial information, applying a logic check, selecting a map technician, prioritizing the order in which the changes are processed, monitoring the status of the requested change, and updating the geospatial information.

### BACKGROUND OF THE INVENTION

1. Field of the Invention

The present invention is directed to a system and method for updating geospatial information such as those used in generation of maps, online maps, and navigational systems. In particular, the present invention is directed to a system and method in which updates are obtained from users of such geospatial information.

2. Description of Related Art

Numerous businesses compile geospatial information and maintain geospatial information systems. The geospatial information is gathered from multiple, disparate sources, and used to build a unified, coherent database which is managed by geospatial information providers. The geospatial information gathered in the database is then sold to various customers that require geospatial information for their business operation. For example, geospatial information may be utilized by delivery companies, online map services that provide map information and routing information to end users, and so forth.

Acquisition of geospatial information for incorporation into a database by a geospatial information provider involves expenditure of significant effort and expense. Resources for creation and maintenance of a geospatial information system having such a database may include satellite imagery, tax maps, digital map datasets, address lists, field data collection trips, proactive phone calls to local authorities, etc. Generally, the information from these resources are evaluated by analysts and entered into the database by map technicians.

One example of a graphic database system is shown in U.S. Pat. No. 5,524,202 to Yokohama which includes a memory unit, a mapping unit and a processing unit. The memory unit stores a file in which graphic data such as map data is registered, the mapping unit maps the contents of the file on a memory space, and the processing unit accesses the mapped memory space to perform operations such as registering, deleting and updating operations over the graphic data of the file. Yokohama further discloses that a plurality of users can reference and update the map data at the same time.

In another example, U.S. Pat. No. 6,216,130 to Hougaard, et al. discloses systems and methods for managing geographic and other data structures. Using an administrator application, an administrator identifies geographic data structures deemed to be of interest to an organization and compiles associated reference information which may include retrieval addresses and display information specifying the display format of the data structures. The administrator can establish relationships between the referenced geographic data structures, tabular data, or other data, which define the manner in which multiple data structures are to be displayed. A user application allows the user to select geographic information of interest, receive the address information, display information from the administrator application, and establishes communication with the remote sources to retrieve and display the relevant geographic data structures. Select users can edit the displayed tabular data, the edits being retrievable by multiple users of an organization.

In yet another example, U.S. Pat. No. 6,415,291 to Bouve, et al. discloses a system and method wherein a user can access a common database from a remote communications port to generate a map or other positional information which locates selected items of interest, e.g., businesses, stores, architectural sites, and the like. The database contains information representing the items of interest, including positional coordinates that discretely locate the vicinity, the vicinity specifying the exact locations of the items of interest in the selected category. The database can be modified from select ports by a system administrator to change, or add to, the information therein.

Geospatial information for any given geographical area is frequently subject to change and may, in some instances, be incorrect. For example, street information changes as new streets are added or routing of existing streets are modified. Thus, geospatial information providers generally actively seek out information regarding such changes to correct and/or update the geospatial information stored in the, database. This is generally attained by sending field technicians that work for the geospatial information providers to actively acquire new information for the database, for example, by driving the streets to collect street data.

Customers that utilize such geospatial information from geospatial information providers frequently have their own databases that contain geospatial information regarding their local street network. Such customer maintained geospatial data can be more current and accurate as compared to the geospatial information from the geospatial information providers who generally acquire and provide information for a larger geographical area.

Presently, most changes to the geospatial information of geospatial information providers are provided in an ad hoc manner. For example, one or more customers may request changes to the geospatial information by submitting an e-mail, telephone call, or mailed paper map which sets forth changes that should be made to the geospatial information such as changing a street name or adding a new street. However, maintenance of literally millions of street information using such an ad hoc method of updating is not efficient and cannot be sustained without expenditure of tremendous amount of resources.

In addition, such method of updating the geospatial information is often not possible since the materials provided by the customer requesting change may not be complete and fail to specifically identify the location for which the changes to the geospatial information should be made. For example, the correspondence from the customer may identify changes for a street in a county which is identified by name, but multiple counties with the same name may exist in numerous different states of the U.S.

As a consequence of the various noted limitations of the conventional method of updating geospatial information, entry of requested changes to update the geospatial information frequently took period of many months. During this time, customers that submitted the requested change would not be aware of whether the changes have been approved or the status of the requested update.

U.S. Pat. No. 6,718,258 to Barton discloses a method and system for obtaining user feedback regarding geographic data. In particular, the reference discloses a reporting program and system whereby end users of computing platforms that use geographic data can make reports about the geographic data. The reporting program can be remotely accessed and used by end users to report perceived errors or inaccuracies in the geographic data. In this regard, a graphical map image is displayed to the end user who marks up the graphical map image to illustrate a change. The reporting program also allows the end user to include text to describe a change. The requested change is captured as a report and used to update or check the geographic database.

Thus, the method and system disclosed in Barton provides a substantially improved process for requesting changes to geographical data in a geographical database. However, the method and system disclosed in Barton only provides minimum utility in the geographical data updating process in that only the submission of change requests are facilitated. Whereas the method and system of Barton provides an effective way for customers to convey more accurate and current geospatial information to geospatial information providers so that the databases maintained by the information providers can be updated, such a feature only addresses a small portion of the process of updating geographical data in a geographical database. In addition, although the quality of information that is provided by the end user may vary widely depending on the end user, this variation in quality of information is not addressed by the method and system disclosed in Barton. Moreover, even when changes are submitted in a generated report, such changes typically take time in order for it to be entered into the geographical database. However, the method and system of Barton does not provide any mechanism for allowing end users to monitor the status of their requested changes.

Therefore, in view of the above, there still exists an unfulfilled need for an effective way for customers to convey more accurate and current geospatial information to geospatial information providers, where the quality of information provided by the customers is improved. There also exists an unfulfilled need for a geospatial information system and method that allows customers to monitor the status of their requested changes and updates. There further exists an unfulfilled need for a geospatial information system and method that facilitates updating of geospatial information provided. There further exists an unfulfilled need for a geospatial information system and method that allows updates to be effectuated in an efficient manner.

### SUMMARY OF THE INVENTION

In view of the foregoing, an advantage of the present invention is in providing an effective way for customers to convey more accurate and current geospatial information to geospatial information providers, where the quality of information provided by the customers is improved.

Yet another advantage of the present invention is in providing a geospatial information system and method that allows customers to monitor the status of their requested changes and updates.

Another advantage of the present invention is in providing a geospatial information system and method that facilitates updating of geospatial information.

Still another advantage of the present invention is in providing a geospatial information system and method that allows updates to be effectuated in an efficient manner.

In accordance with one aspect of the present invention, a geospatial information system is provided, the system including a database adapted to store geospatial information, a processing unit in electronic communication with the database and being adapted to access and retrieve the geospatial information from the database, a tool permissions module to associate a tool permission level with a user, and a user interface module including a plurality of enhancement tools to allow a user to generate an enhancement request that requests a change to the geospatial information stored in the database, each of the plurality of enhancement tools being adapted to request a specific type of change to the geospatial information stored in the database, and being generated based on the tool permission level associated with the user so that the user is provided with a plurality of tools corresponding to the tool permission level. In accordance with one implementation, the geospatial information may be an address, street name, street direction, intersection, and/or street path, and the tool permission level associated with the user is determined based on a login identification assigned to the user.

In accordance with another aspect of the present invention, the geospatial information system includes a user interface module adapted to display a graphical map and having an enhancement tool for allowing a user to generate an enhancement request that requests a change to the geospatial information stored in the database by marking changes on the graphical map, and a monitoring module adapted to dynamically monitor a status of the enhancement request or change requested in the enhancement request and to graphically indicate the status in the graphical map using a plurality of colors that represent different status.

In accordance with yet another aspect of the present invention, the geospatial information system includes a user interface module having an enhancement tool to allow a user to generate an enhancement request that requests a change to the geospatial information stored in the database, and an audit module adapted to apply at least one logic check to determine whether the change requested in the enhancement request is consistent with other confirmed geospatial information stored in the database, and to generate an edit failure notification to the user if the change requested in the enhancement request is logically inconsistent with other confirmed geospatial information stored in the database.

In yet another aspect of the present invention, the geospatial information system includes a user interface module including an enhancement tool for allowing generation of an enhancement request that requests a change to the geospatial information stored in the database, and a workflow management module that automatically selects a technician for processing the enhancement request from a list of plurality of technicians based at least on the change requested in the enhancement request and qualifications of the technician.

In accordance with another aspect of the present invention, a method for updating geospatial information is provided, the method including the steps of providing a database adapted to store geospatial information, accessing the database to retrieve the geospatial information from the database, associating a tool permission level to a user, and generating a customized interface including a plurality of enhancement tools to allow the user to request changes to the geospatial information stored in the database, each of the plurality of enhancement tools being adapted to request a specific type of change to the geospatial information stored in the database, and being generated based on the tool permission level associated with the user.

In another embodiment, the method for updating geospatial information includes the steps of generating and displaying an electronic graphical map based on the geospatial information retrieved from the database, requesting a change to the geospatial information stored in the database by marking the change on the displayed electronic graphical map, monitoring a status of the requested change, and automatically indicating the status of the requested change in the displayed electronic graphical map using colors that each represent a particular status of the requested change.

In still another embodiment, the method for updating geospatial information includes the steps of displaying an electronic graphical map based on the geospatial information retrieved from the database, requesting a change to the geospatial information stored in the database by marking the change on the displayed electronic graphical map, and applying at least one logic check to determine whether the change requested is consistent with other confirmed geospatial information stored in the database.

In yet another embodiment, the method for updating geospatial information includes the steps of displaying an electronic graphical map based on the geospatial information retrieved from the database, requesting a change to the geospatial information stored in the database by marking the change on the displayed electronic graphical map, and automatically selecting a technician for processing the enhancement request from a list of plurality of technicians based on the change requested and qualifications of the technician.

In another embodiment, the method for updating geospatial information includes the steps of requesting a plurality of changes to the geospatial information stored in the database by marking the changes on the displayed electronic graphical map, and electronically prioritizing the order in which the changes are processed.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a geospatial information system in accordance with one example embodiment that is connected to a network.

FIG. 2 is a flow diagram illustrating a method for updating geospatial information in accordance with another aspect of the present invention.

FIG. 3 is a flow diagram illustrating in detail, the operations of the geospatial information system of FIG. 1.

FIG. 4 is a user interface screen in accordance with an example implementation of the present invention.

FIG. 5 is the user interface screen of FIG. 4 showing the use of the “Add” tool of the toolbar.

FIG. 6 is a window that is displayed for allowing generation of an enhancement request to add a new road.

FIG. 7 is the user interface screen of FIG. 4 showing the use of the “Update” tool of the toolbar.

FIG. 8 is a window that is displayed for allowing generation of an enhancement request to modify road attributes.

FIG. 9 is the user interface screen of FIG. 4 showing the use of the “Delete” tool of the toolbar.

FIG. 10 is a window that is displayed for allowing generation of an enhancement request to delete an existing road.

FIG. 11 is the user interface screen of FIG. 4 showing the use of the general problem point tool of the toolbar.

FIG. 12 is a window that is displayed for allowing generation of an enhancement request to request a change to geospatial information regarding a particular location.

FIG. 13 is the user interface screen of FIG. 4 showing the status of various enhancement requests submitted by a user in accordance with one example embodiment.

FIG. 14 is an example entry of the listing database showing skills and experience of a map technician.

FIG. 15 is a sample map tile that is displayed to a map technician.

FIG. 16 is a sampling of logic checks that may be performed to ensure that the requested changes are consistent with other geospatial information.

### DETAILED DESCRIPTION OF THE PREFERRED EMBODIMENT

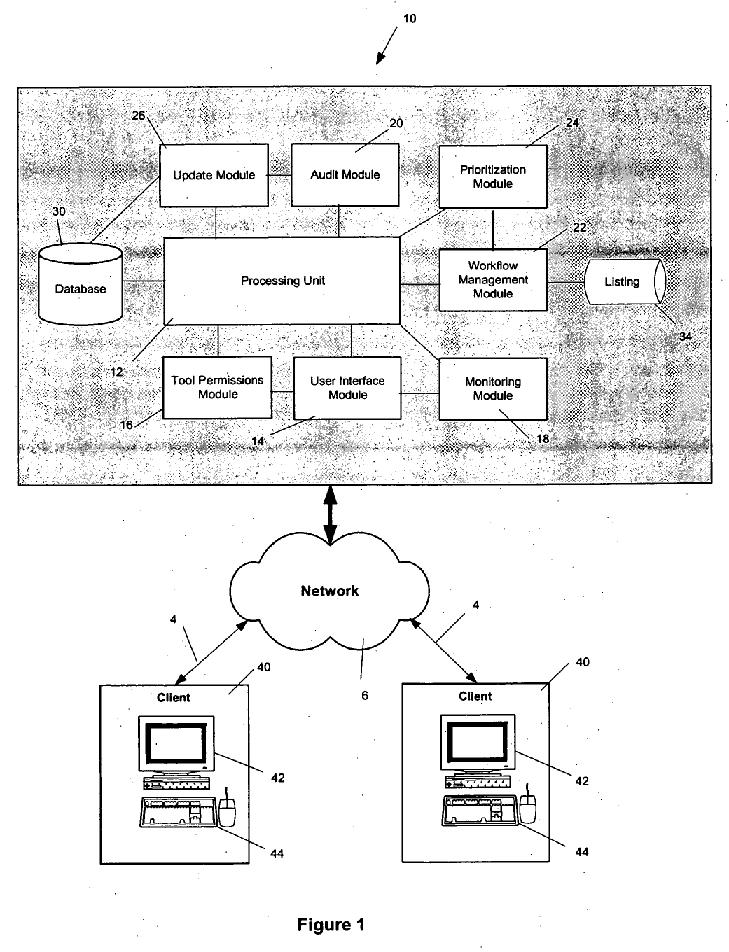

The geospatial information system 10 as shown in FIG. 1, and the method for updating geospatial information described herein below, provide an effective system and method for allowing users of the system to convey more accurate geospatial information to the administrator of the geospatial information system 10. In particular, the geospatial information system and method of the present invention facilitate updating of geospatial information and to allow such updating of geospatial information to be effectuated in a very cost effective and efficient manner.

In particular, FIG. 1 illustrates a schematic illustration of the geospatial information system 10 in accordance with one embodiment of the present invention. As shown, the geospatial information system 10 includes a processing unit 12 with a plurality of functional modules that are connected thereto for allowing the geospatial information system 10 to perform a variety of functions described in detail below. In addition, the geospatial information system 10 is further provided with a database 30 for storage of geospatial data and information, such as addresses, street names, street directions, intersection information, street paths, etc.

The geospatial information system 10 is also provided with a listing database 34 that includes identities of map technicians, together with each technicians' skill sets and qualifications. The map technicians work to maintain accurate and up-to-date geospatial information provided by the geospatial information system 10. In this regard, the map technicians process requested changes to the geospatial data and information stored in the database 30. The illustrated embodiment of the geospatial information system 10 further includes a user interface module 14, a tool permissions module 16, a monitoring module 18, an audit module 20, a workflow management module 22, a prioritization module 24, and an update module 26, the functions of each being further described below.

In the illustrated example, the geospatial information system 10 is connected to a distributed network 6, which may be the Internet, for example. Client systems 40 that are remotely located from the geospatial information system 10, are also adapted to electronically communicate with the geospatial information system 10 through connection 4 to a distributed network 6. Thus, users, such as customers of the geospatial information provided by the geospatial information system 10, can access the functional features of the geospatial information system 10 described herein using the remotely located client systems 40.

The various components or modules of the geospatial information system 10 shown and discussed herein may be implemented with any type of appropriate hardware and/or software that reside in the form of computer readable storage medium having executable instructions, and computer architecture. Thus, whereas the geospatial information system 10 of the present embodiment is illustrated and discussed herein as having various modules which perform particular functions, it should be understood that these modules are merely schematically illustrated based on their function for clarity purposes, and do not necessarily represent specific hardware or software. Of course, in other implementations, the functions of the different modules may be combined or separately implemented in any appropriate manner.

It should also be evident from the above that the geospatial information system 10 may be implemented using a server, personal computer, etc., or any combination of devices, the processing unit 12 representing a CPU, for example. Furthermore, the geospatial information system 10 may be implemented as a single device at a single location as shown, or implemented as multiple devices at a single, or multiple, locations that are connected together using any appropriate communication protocols over any communication medium such as electric cable, fiber optic cable, or in a wireless manner. Correspondingly, the present invention as schematically embodied in FIG. 1 should not be construed to limit the geospatial information system 10 of the present invention, but be understood to merely be a schematic example.

The remotely located client systems 40 may also be implemented with any appropriate devices for allowing users to access geospatial information system 10 via connection 4 to the distributed network 6. For example, the client systems may be implemented using personal computers as shown, or in other implementations, using portable computers, thin clients, handheld devices such as mobile phones or PDAs, and the like. Client systems 40 may include an input device 42 such as a keyboard and mouse shown, and an output device 44 such as a screen, these devices allowing the user of each of the client systems 40 to provide information to, and receive information from, the geospatial information system 10 via the distributed network 6. Of course, the described implementation of the client systems 40 is merely one example, and in other embodiments, the present invention may be implemented differently.

Referring again to FIG. 1, the processing unit 12 described above is in electronic communication with database 30 of the geospatial information system 10, the database 30 being adapted to store geospatial information. The geospatial information may be any information data associated with geography or location. For example, as previously noted, the geospatial information may be addresses, street names, street directions, intersections, and/or street path information. Of course, the geospatial information stored in the database 30 may be other information as well. The processing unit 12 is adapted to access and retrieve the geospatial information from the database 30, and to provide processing required for the various modules of the geospatial information system 10 to perform the functions described.

In operation, the user logs into the geospatial information system 10 via the network 6 through a login screen that is generated by the user interface module 14. The processing unit 12 is connected to tool permissions module 16 that associates a tool permission level with the logged in user, for example, using the user's login identification. The tool permissions module 16 then provides a plurality of enhancement tools for inclusion in the user interface module 14 so that the tools are displayed to the user.

The plurality of enhancement tools that are provided by the tool permissions module 16 and included in the user interface module 14 allow a user to generate one or more enhancement requests. An enhancement request sets forth a requested change to the geospatial information stored in the database 30 so that the database 30 can be updated by incorporating the requested change into the geospatial information stored in the database 30. The enhancement requests may be implemented in any appropriate manner, and is preferably implemented as an electronic file that is generated by the user of the geospatial information system 10 in the manner described in further detail below.

For example, the enhancement request may be a textual form or document that is formatted to set forth a description of the requested change so that it can be easily understood and processed. The enhancement request may also be a graphical illustration showing a geographical area, wherein the requested change is illustrated graphically as a mark up on the geographical illustration. Of course, the enhancement request may be a combination of the textual document and the graphical illustration described above, or implemented in any other appropriate manner.

In the illustrated embodiment, each of the plurality of enhancement tools are preferably adapted to request a specific type of change to the geospatial information stored in the database 30. For example, one enhancement tool may allow requesting of changes to addresses where another enhancement tool may allow requesting of changes to street directions, etc. In addition, in the illustrated embodiment, each of the plurality of enhancement tools provided by the tool permissions module 16 and included in the user interface module 14 are based on the tool permission level associated with the user. Thus, the users of the geospatial information system 10 are provided with customized user interfaces having a plurality of tools corresponding to the user's tool permission level. This allows the administrator of the geospatial information system 10 to control the type of changes to the geospatial information that is requested by a particular user/customer, thereby indirectly controlling the quality of the requested change.

For example, if the user is a delivery courier, it can be expected that the user will have accurate, and up-to-date information regarding addresses, and that any requested changes to addresses stored in database 30 will likely be a valid request that should be effectuated in the database 30. Thus, the tool permissions module 16 may set the tool permissions level such that the user is provided with tools that allow generation of enhancement requests that set forth changes to address data stored in the database 30. If the user is a signal maintenance person, it can be expected that the user will have accurate and up-to-date information regarding intersections. Thus, the tool permissions module 16 may set the tool permissions level such that the user is provided with tools that allow generation of enhancement requests that set forth changes to intersection information that are stored in the database 30.

In the above described manner, the administrator of the geospatial information system 10 can ensure that users are allowed to only generate enhancement requests for requesting certain types or categories of changes, so that the administrator can be somewhat confident as to the accuracy of the requested change based on the source of the enhancement request. It can be appreciated that the quality of the requested changes to the data stored in the database 30 will likely be higher with respect to accuracy, than would otherwise be attained if every user was allowed to request all types or categories of change to the geospatial information. Correspondingly, this feature of the geospatial information system 10 of the present invention reduces the number enhancement requests that set forth erroneous changes to the geospatial information.

In addition to the above, the enhancement requests that are generated by the user using the enhancement tools are checked by the geospatial information system 10 to ensure the quality of the requested change. In this regard, the present embodiment of the audit module 20 of the geospatial information system 10 is adapted to apply at least one logic check to determine whether the change requested in the enhancement request is consistent with other confirmed geospatial information stored in the database 30.

If the audit module 20 of the geospatial information system 10 determines that the change requested by the generated enhancement request is consistent with other confirmed geospatial information stored in the database 30, it is provided to the workflow management module 22 for further processing by map technicians. If the change requested by the generated enhancement request is inconsistent with other confirmed geospatial information stored in the database 30, the enhancement request is flagged with an indicator that advises the administrator and/or the user that the change is inconsistent, and optionally, be provided to the workflow management module 22 for confirmation. In such instances, appropriate measures may be taken to confirm the accuracy of the requested change, for example, by sending out a field technician to confirm the accuracy of the requested change.

In other words, the illustrated embodiment of the geospatial information system IO is adapted to determine whether the requested change in the generated enhancement request makes sense in view of the already existing geospatial information. If the requested change does make sense, there is an increased likelihood that the requested change is, in fact, accurate and that the requested change reflects up-to-date geospatial information. However, if the requested change does not make sense in view of the already existing geospatial information, the generated enhancement request is flagged so that the requested change can be confirmed to be accurate before incorporating the change into the geospatial information system 10 so that incorporating of inaccurate geospatial information is avoided. This confirmation may be attained by sending out field technicians that go to the location where the change has been requested to verify the accuracy of the requested change.

For example, an enhancement request for an address number change may be examined by the audit module 20 of the present embodiment and compared to other confirmed address numbers along the same street location to determine if there are any inconsistencies. In particular, if the address numbers on the street is known to increase in one direction, but the requested address number change would result in an address pattern that increases in the opposite direction, the requested change would be inconsistent. The audit module 20 then flags the enhancement request due to this perceived inconsistency so that additional investigation may be conducted to determine whether the requested change is, in fact, accurate and should be incorporated into database 30, or inaccurate and should be rejected. In another example, if an enhancement request sets forth an address change where the address is an odd number whereas confirmed addresses on the same side of the street are even numbers, the enhancement request is flagged by the audit module 20 with an indicator that advises the administrator and/or the user that the change is inconsistent for confirmation. Of course, the above only sets forth two illustrative examples of logic checks that may be performed by the audit module 20 if changes to an address are requested in an enhancement request, and other logic checks may be implemented as well.

In another example, the enhancement request may request a change to a street name. In such an instance, the audit module 20 of the present embodiment determines whether there exists a different street having the same name within the proximity of the street for which the name change is requested. If the geospatial information stored in the database 30 indicates that a different street having the same name does exist in close proximity, the enhancement request is flagged by the audit module 20 with an indicator that advises the administrator and/or the user that the change is inconsistent. The inconsistency can then, be investigated to confirm whether the requested change is accurate or inaccurate. Of course, the above is only one example of a logic check that may be performed if changes to the name of the street are requested in an enhancement request, and other logic checks may be implemented as well.

The enhancement request may request a change to a direction of a street, for example, request a change indicating that the street is one way in a particular direction. In such an instance, the audit module 20 conducts a logic check to ensure that the direction requested is consistent with other confirmed street directions or other information that are stored in the database 30. Thus, if the audit module 20 of the present embodiment determines that other street direction or intersection information for the same street at a different location indicates that the street allows traffic to pass in a direction opposite to that requested in the enhancement request, the audit module 20 flags the request with an indicator that advises the administrator and/or the user that the change is inconsistent with other geospatial information stored so that the requested change can be confirmed prior to being effectuated in the database 30. Of course, the above is only one example of a logic check that may be performed if changes to the street direction are requested in an enhancement request, and other logic checks may be implemented as well.

In yet another example, the enhancement request may request a change to information associated with a particular intersection. Such information may be the identity of which streets form the intersection, which lanes allow to flow in a particular direction such as turns, etc. The audit module 20 of the present embodiment is adapted to conduct an audit check to determine whether the requested change in the enhancement request is consistent with other geospatial information in the database 30 regarding the intersection and the streets that form the intersection. For instance, the requested change may indicate a turn into a street is allowed at the particular intersection. However, other geospatial information may indicate that the street is a one way street that flows in a direction opposite to that required to make the turn indicated in the enhancement request. The audit module 20 of the present embodiment flags the request with an indicator since the requested change is inconsistent with other geospatial information stored in the database 30. In another example, the geospatial information may indicate that an on-ramp from one street to another is located on one side of the street, the enhancement request requesting changes to the geospatial information so that the on-ramp is located on the other side of the street. However, the audit module 20 would determine the requested change to be inconsistent if the geospatial information indicates that there is already an on-ramp on the other side of the street. Thus, the audit module 20 flags the request with an indicator for further investigation or confirmation. Of course, the above are only examples of logic checks that may be performed and other logic checks may be implemented with respect to intersections.

The enhancement request may request a change to street path information, for example, such that a particular street's topography is changed to curve to the left instead to the right. However, other geospatial information stored in the database 30 may indicate that there is a parallel street on the left so that if the street path does curve left, the streets will intersect each other, but no other geospatial information in the database 30 indicates that the streets intersect. The audit module 20 then flags the enhancement request with an indicator since the requested change is inconsistent with other geospatial information stored in the database 30 so that the requested change can be further evaluated and confirmed. Again, this is only one example of a logic check that may be performed and other logic checks may be implemented with respect to street path.

It should be noted that the above discussion merely provides example logic checks that may be performed by the audit module 20 for various types of enhancement requests. Of course, the audit module 20 may be implemented to perform other logic checks for the various types of enhancement requests discussed, as well as for other types of enhancement requests. In addition, it should also be noted that whereas the above described logic checks are preferably performed by the audit module 20, other embodiments of the geospatial information system may be implemented so that such logic checks are performed by map technicians. In this regard, the map technicians may be provided with various tools to facilitate determining of whether a requested change in an enhancement request is consistent, or inconsistent, with other geospatial information stored in the database 30. Of course, a geospatial information system including the audit module 20 as described above relative to FIG. 1 is preferable so that performing of such logic checks can be automated, thereby minimizing human resources required, as well as costs.

As noted, if upon performing one or more logic checks, the requested change set forth in the enhancement request is determined to be inconsistent with other geospatial information stored in the database 30, the enhancement request is flagged with an indicator so that appropriate measures may be taken to confirm the accuracy of the requested change. For example, a field technician may be sent out to confirm the accuracy of the requested change. If the requested change of the enhancement request is in fact, inaccurate, it is rejected by the geospatial information system 10 and a notice to that effect can be sent to the user that submitted the enhancement request and/or the rejected status of the requested change can be graphically indicated on a graphic map as described in further detail below.

It should also be evident that the geospatial information system 10 of the present invention allows a plurality of enhancement requests to be generated and processed. The plurality of enhancement requests may be generated by a single user through a single client system 40 and/or by a plurality of users through a plurality of client systems 40 accessing the geospatial information system 10 through the network 6. The plurality of enhancement requests may be generated using the user interface with customized tools provided by the user interface module 16 and the tool permissions module 16. As described, the geospatial information system 10 processes the plurality of enhancement requests and performs logic checks to ensure consistency of the enhancement requests with other confirmed geospatial information.

Once the changes requested in a enhancement request is determined to be consistent or confirmed to be accurate, the geospatial information system 10 prioritizes the enhancement requests so that they can be processed and effectuated in the database 30. In this regard, the prioritization module 24 of the geospatial information system 10 sequences the order in which the plurality of enhancement requests is processed by the map technicians. The prioritization module 24 establishes a queue of enhancement requests to be processed, and further sequences the order for processing the enhancement requests in any appropriate manner. The prioritization module 24 is preferably implemented to take into consideration various factors in sequencing the enhancement requests. For example, the sequencing may be based on contractual obligations to the user requesting the change that sets forth the time frame in which the enhancement requests must be processed. In another example, the sequencing may be based on the type of change requested where some types of changes are considered to be of higher priority than others. Of course, these are merely two examples of how the prioritization module 24 can sequence the order in which the plurality of enhancement requests are processed. Thus, other factors may be considered by the prioritization module 24 in other embodiments.

The workflow management module 22 of the geospatial information system automatically selects a technician from the listing database 34 of plurality of technicians for processing the enhancement requests. The workflow management module 22 of the illustrated embodiment selects a technician based on the change to the geospatial information that is requested by each of the enhancement requests, as well as the qualifications of the technician in the listing database 34. In this regard, the listing database 34 is provided with both, the identity of the technicians, as well as their skills or qualifications. Of course, other considerations may be taken into account in selecting a technician. For example, the existing work load may be considered so that one technician is not overly burdened in comparison to other technicians. Thus, the workflow management module 22 ensures that the generated enhancement requests are assigned to, and are processed by, map technicians having the requisite qualifications and skills required to efficiently and accurately process the changes to the geospatial information stored in database 30.

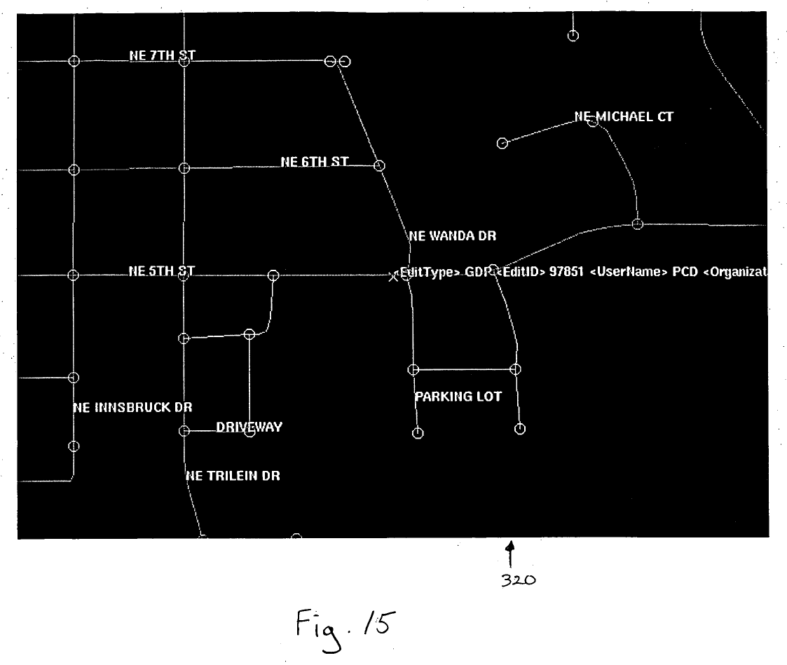

The map technicians that maintain the geospatial information system 10 then process the enhancement requests. In particular, upon selection of an enhancement request for processing, the map technician is provided with a map tile as describe below relative to FIG. 15 that allows the map technician to enter the requested change. In this regard, the changes may be entered in a working copy of database 30 that allows the geospatial information to be modified prior to being uploaded to the database 30.

After the requested change in the enhancement request is fully processed, the update module 26 of the geospatial information system 10 updates the geospatial information stored in the database 30 to reflect the changes processed. The update module 26 of the illustrated embodiment is preferably further adapted to deliver the updated geospatial information to one or more users of the geospatial information system 10. This allows the users of the geospatial information system 10 to have the most recent and up-to-date geospatial information for use.

Yet another feature of the geospatial information system 10 in accordance with the illustrated embodiment of FIG. 1 is provided by the monitoring module 18. The monitoring module 18 of the illustrated embodiment is adapted to dynamically monitor a status of the enhancement request and/or the change requested in the enhancement request. In this regard, the status of each of the enhancement request and/or the change requested is monitored based on identity of the user that submitted the enhancement request. This allows the monitoring module 18 to graphically display the status of the enhancement requests and/or the changes requested on a graphical map that is displayed to the user upon accessing the geospatial information system 10.

For example, the monitoring module 18 of the present invention may be adapted to graphically indicate the status of the enhancement requests and/or the changes requested by a particular user in a graphical map using a plurality of colors. Each color may indicate or represent a different status so that the status of each of the changes requested in the enhancement requests can be determined quickly, and easily by the user.

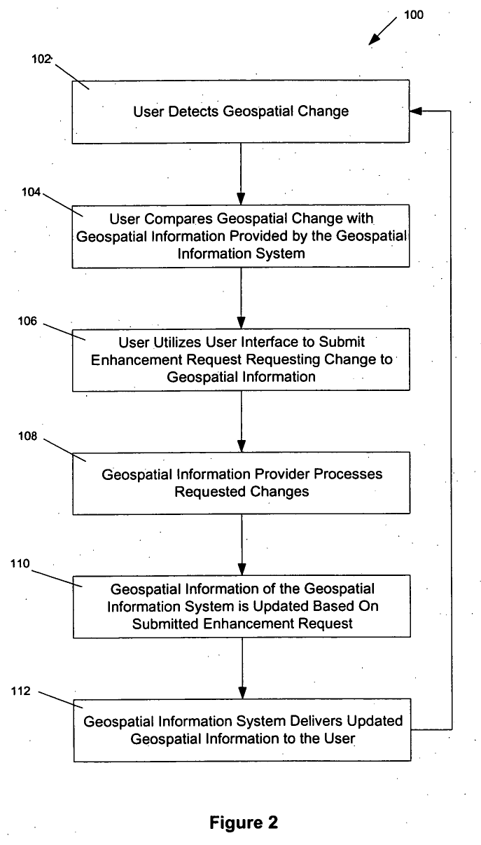

FIG. 2 illustrates a flow diagram 100 that shows a method for updating geospatial information. As shown, in step 102, the user (such as a customer) of the geospatial information system 10 detects geospatial change, for example, change in addresses, street names, street directions, etc. In step 104, the user compares the geospatial change with the geospatial information provided, for example, by the geospatial information system 10. In step 106, the user utilizes the interface that is provided by the geospatial information system to submit an enhancement request to the geospatial information system 10 requesting a change to the geospatial information.

The geospatial information provider such as the administrator of the geospatial information system 10, processes the requested changes in step 108. In step 110, the geospatial information that is stored in database 30 is updated based on the submitted enhancement request. Moreover, in step 112, the geospatial information system 10 delivers the updated geospatial information to the user. In the above described manner the geospatial information that is provided and stored by the geospatial information system 10 of FIG. 1 may be readily updated with more current geospatial information in a cost effective and efficient manner. Of course, the above described method is merely one example of a method for updating geospatial information.

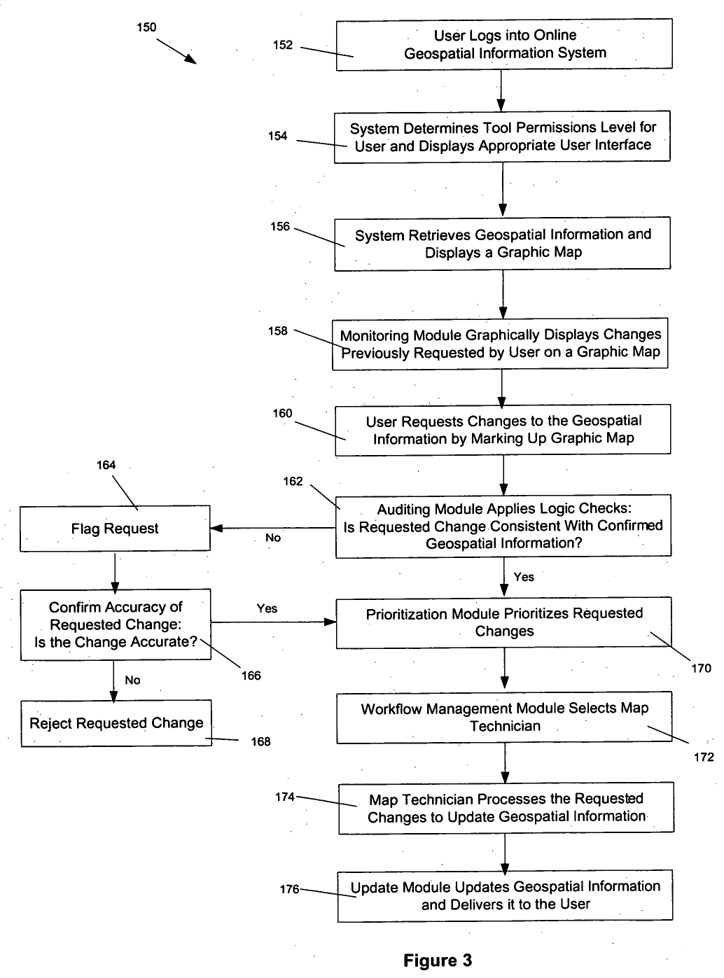

FIG. 3 shows a flow diagram 150 that illustrates in detail, the operations of the geospatial information system 10 described above. As shown, in step 152, a user logs into the geospatial information system 10 via a network 6. The geospatial information system 10 determines the appropriate tool permissions level for the user as described relative to the tool permissions module 16, and further displays an appropriate user interface that is generated by the user interface module 14 in step 154, the user interface including appropriate tools for the user. In step 156, the geospatial information system retrieves the geospatial information system from the database and displays a graphic map on the generated user interface. In step 158, a monitoring module 18 graphically displays status of changes that were previously requested by the user in enhancement requests. As noted, this may be attained using different colors to indicate different status of the requested changes and/or enhancement requests. The user then requests changes to the geospatial information system in step 160 by marking up the requested change on the graphically displayed map, and generating an enhancement request in the manner previously described.

In step 162, the auditing module 20 applies logic checks to determine whether the requested change is consistent with confirmed geospatial information stored in the database 30. If the requested change is inconsistent with the geospatial information stored in the database 30, the enhancement request is flagged in step 164 for further processing, for example, for confirmation by a field technician in step 166. If the field technician determines that the requested change is inaccurate in step 166, the requested change is rejected by the geospatial information system 10 in step 168. As noted, the user requesting the change may be notified of the rejection, or otherwise informed of the rejection on a graphic map by the monitoring module 18.

If the requested change is consistent with the geospatial information in step 162, or is otherwise confirmed to be accurate in step 166, the prioritization module 24 prioritizes the requested changes for the map technician assigned to process the enhancement request in step 170. The workflow management module 22 of the geospatial information system 10 then selects an appropriate map technician in step 172 to further process the enhancement request. The map technicians that maintain the geospatial information system 10 selects an enhancement request for processing and enters the requested change in step 174. As noted above, the present embodiment may be implemented so that selection of an enhancement request causes a display of a map tile as described below relative to FIG. 15, and enters the requested change thereon.

Finally, in step 176, the update module 26 updates the geospatial information stored in the database 30, and delivers the updated information to the user. Of course, the above described method for operating the geospatial information system 10 is merely provided as one example, and may be changed or modified in other embodiments of the present invention.

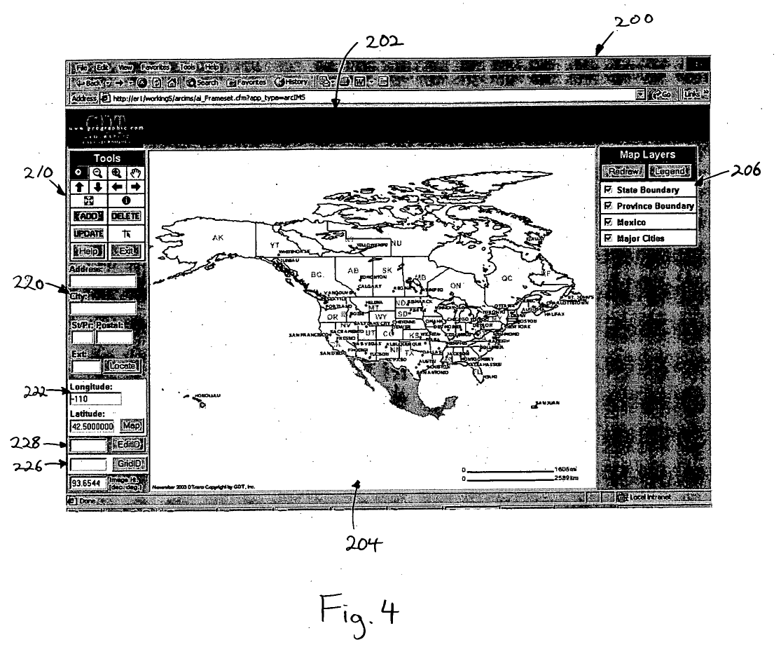

FIGS. 4 to 16 show various screen shots and electronic files associated with an example implementation of the geospatial information system 10 of the present invention which is implemented on a computer system. As previously noted, the geospatial information system 10 is accessed by users via client systems 40 that are connected to the network 6 described above relative to FIG. 1. These figures are discussed briefly herein to further describe the function and uses of the geospatial information system and the method for updating geospatial information of the present invention. Of course, it should be appreciated that these figures merely show one example implementation, and the present invention is not limited thereto.

FIG. 4 illustrates one example embodiment of a user interface screen 200 that is generated by the user interface module 14 of the geospatial information system 10, and is displayed to the user at the client system 40 through network 6 to allow the user to obtain geospatial information, and to generate enhancement requests. In the illustrated embodiment, mapping software such as ArcIMS™ is used to generate and display a graphical map in a web browser using the geospatial information stored in database 30. As explained in further detail below, the user of the geospatial information system 10 interacts with the user interface screen 200 to interact with the geospatial information system 10 to allow updating of geospatial information as previously described.

The illustrated embodiment of the user interface screen 200 is provided with a message bar 202 that is utilized by the geospatial information system 10 to display various messages to the user, such as instructions for proceeding further in generating enhancement requests. In addition, the user interface screen 200 further includes a map window 204 that displays a graphical image of a map in various scalings as described below, the graphical map facilitating the user in requesting changes to the geospatial information.

The user interface screen 200 further includes a toolbar 210 that allows the user to display in various detail, maps generated from the geospatial information stored in database 30, and to further allow the user to generate enhancement requests that request changes to the geospatial information. The toolbar 210 is preferably customized for each user in the manner described above relative to the tool permissions module 16, for example, using the login information, so that each user is provided with appropriate tools that allow generation of enhancement requests that are likely to be accurate. The functions of the various tools set forth in the toolbar 210 of the illustrated embodiment are discussed in further detail below.

In the illustrated embodiment of the user interface screen 200, map layer control window 206 is provided to allow the user of the geospatial information system 10 to alter the map that is displayed in the map window 204. Depending on the scale of the map that is displayed in the map window 204, the user can select to display, or omit, particular detail associated with the displayed map. For example, in the illustrated map of the North American continent, various level of detail has been indicated to be displayed in the map layer control window 206. Thus, corresponding to the selected boxes, the state boundary, province boundary, country of Mexico, and major cities are displayed in the map that is shown in the map window 204. Buttons indicated with “Redraw” and “Legend” are also provided to allow the user to update the displayed graphical map, and to further obtain clarifying information regarding what is shown in the displayed graphical map.

In the illustrated example, the user selects the desired province or state from the map displayed in the map window 204 using a mouse, or other pointing device, to enlarge the region selected in the map window 204. In another option, the user can enter the address in the address fields 220 and select the “Locate” button to display a map of the area encompassing the entered address. Alternatively, the user may enter coordinates of longitude and latitude in the coordinate window 222, and select the “Map” button to display an enlarged map of the location having the inputted coordinates.

In still another alternative, the user can enter a grid ID number in the grid window 226, and select the “GridID” button to display a particular map corresponding to the grid ID entered, each grid ID corresponding to a particular geographical area map. Moreover, in yet another alternative, the user can input an edit ID that is associated with a previously submitted enhancement request in the edit ID window 228, and select the “EditID” button to display a map showing the geographical area for which a change was requested in the previous enhancement request. Of course, the above described methods and fields that may be used to display an appropriate map in the map window 204 are merely provided as examples, and other methods may be provided in other implementations of the user interface screen 200.

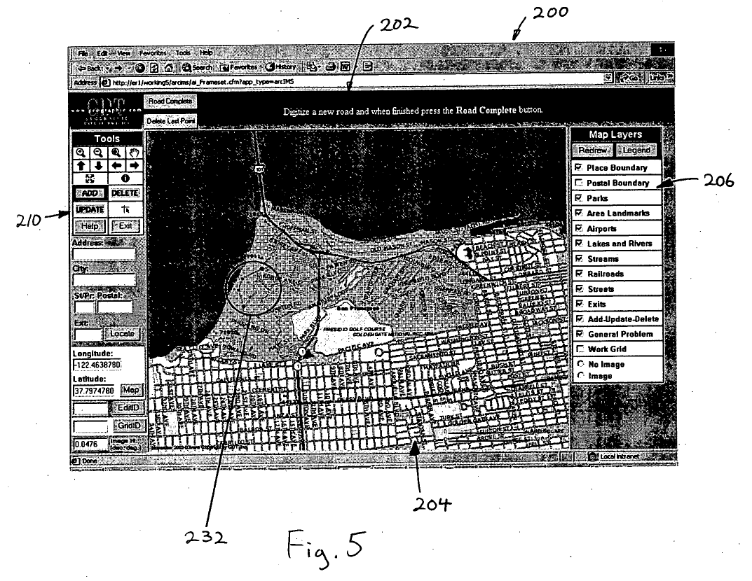

FIG. 5 shows the user interface screen 200 with a local map displayed within the map window 204. As can be seen, a specific location was zoomed in such that various details of the geographical location can be seen. In particular, as shown in the map layer control window 206, geographical landmarks and street information is displayed. The map that is shown in the map window 204 is retrieved and generated from the geospatial information stored in the database 30 of the geospatial information system 10. The location of the desired map is indicated by selecting a geographical location in the map shown in FIG. 4, for example, or in any other appropriate manner such as by entering the coordinate information or address information, etc. as previously described.

As also shown, the toolbar 210 includes various tools for changing the views of the map that is displayed in the map window 204. In particular, selectable buttons are provided to allow various magnification of the map that is displayed in the map window 204, these buttons being illustrated with a magnifying glass. In addition, a button with an illustration of a hand is provided to allow “grabbing” the map so that it can be moved within the map window 204 by depressing a button on a pointing device (such as a mouse), and moving the pointing device. Moreover, the user is also provided with buttons to allow scrolling along the map displayed in any desired direction by selecting buttons with a directional arrow indicated thereon, the directional arrow indicating the direction in which the map is to be scrolled within the map window 204.

The toolbar 210 is provided with tool buttons which, in the illustrated embodiment, include buttons identified with “Add,” “Delete,” “Update,” and an intersection symbol “†” for entering location of a general data problem. Each of these functional tools is discussed in further detail herein below. Of course, the identifying text or symbol noted with respect to the toolbar 210 are merely provided as examples of how a user interface may be generated with appropriate tools, and other implementations of the present invention may provide a different user interface having tools that are also implemented or identified differently.

In the illustration of FIG. 5, the “Add” button of the toolbar 210 is selected. The “Add” button allows the user to generate an enhancement request in which a new road is requested to be added to the database 30 of the geospatial information system 10. Upon selection of the “Add” button of the toolbar 210, the user interface module 14 allows the user to mark up the map that is displayed in the map window 204 to graphically illustrate the new road that is being requested to be added. In this regard, in the illustrated embodiment, the user points a cursor to the desired start location of the new road using an input device such as a mouse, and clicks on that location with the input device, and repeats this for several points, thereby digitizing points along the path of the new road until the new road terminates. An example addition of a new road is shown in circle 232, the digitized points also being shown therein. Of course, provisions may be made to allow deletion of incorrectly digitized points. For example, pressing the “Delete Last Point” button provided in the message bar 202 allows the user to delete an erroneously digitized point.

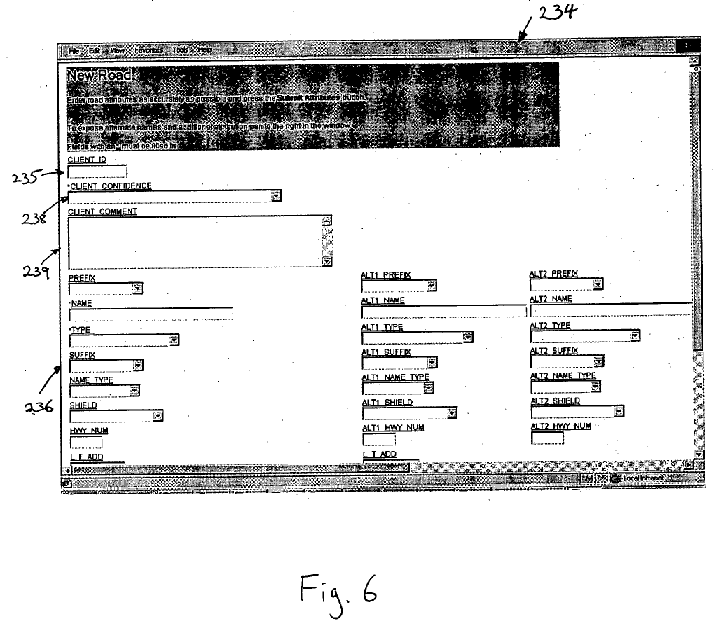

Upon completion, the user selects the “Road Complete” button in the message bar 202. The user interface module 14 of the illustrated embodiment is adapted to automatically fill in a line connecting the digitized points, and displays the new road on the map displayed in the map window 204 as shown in the circle 232 of FIG. 5. In addition, in the illustrated embodiment, the “New Road” window 234 shown in FIG. 6 is also displayed to the user upon selection of the “Road Complete” button in the message bar 202. As can be seen, the displayed “Road Complete” window 234 requires the user to enter some specific information to generate an enhancement request that requests the addition of a new road that has been added to the displayed graphical map shown in the map window 204.

In particular, in the illustrated embodiment, the user may be required to enter a client identification number in the “Client ID” field 235 to ensure that the user is authorized to submit enhancement requests for a new road. The user is also requested to enter attributes of the newly added road including the name, suffix, and prefix of the road using the corresponding fields and/or drop down menus generally indicated at 236. Furthermore, the user generating the enhancement request is requested to indicate the confidence level to which the user is certain of the accuracy of the provided information by selecting an appropriate confidence entry from the “Client Confidence” drop down menu 238. The user can also type in comments in the comment field to explain any other details for the road being requested to be added in the “Client Comment” field 239. A “Submit Attributes” button (not shown) is provided toward the bottom of the “New Road” window 230 which, upon selection, submits the generated enhancement request to the geospatial information system 10 for further processing in the manner previously described.

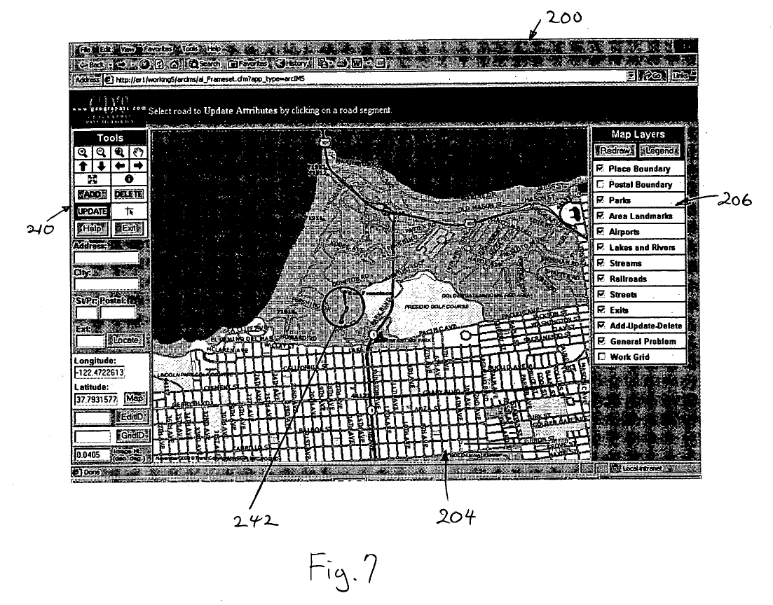

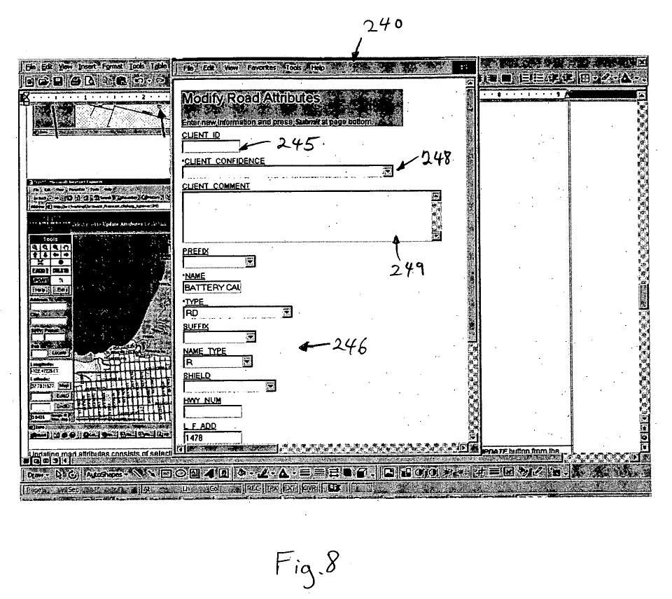

Referring now to FIG. 7, road attributes may be modified or updated by selecting “Update” button provided in the toolbar 210 of the user interface screen 200. Selection of the “Update” button provides a cursor that allows the user to select a road to be updated or modified. Upon selection, the selected road may be highlighted for easy identification as shown in the circle 242. A “Modify Road Attributes” window 240 as shown in FIG. 8 is then displayed to the user by the geospatial information system 10 to allow generation of an enhancement request that sets forth the modifications to the selected road.

In the illustrated embodiment, the user may be required to enter a client identification number in the “Client ID” field 245 to ensure that the user is authorized to submit enhancement requests for updating road attributes. The name, prefix, and/or suffix, as well as the number, and other various parameters of the selected road, are provided in the corresponding fields generally indicated at 246 of the window 240 so that they can be changed by the user. Furthermore, the user generating the enhancement request is requested to indicate the confidence level to which the user is certain of the accuracy of the provided update information by selecting an appropriate confidence entry from the “Client Confidence” drop down menu 248. The user can also type in comments to explain any other details for the road being requested to be added in the “Client Comment” field 249. A “Submit” button (not shown) is provided toward the bottom of the “Modify Road Attributes” window 240 which, upon selection, submits the generated enhancement request to the geospatial information system 10 for further processing.

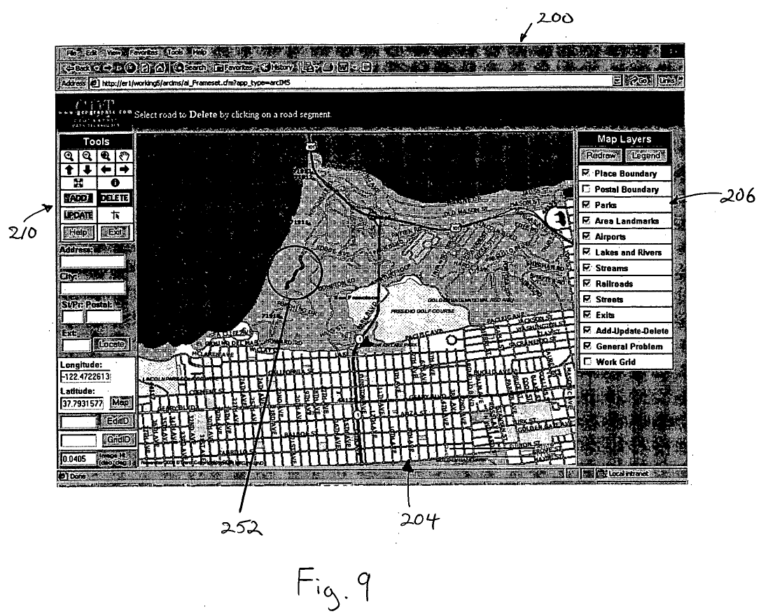

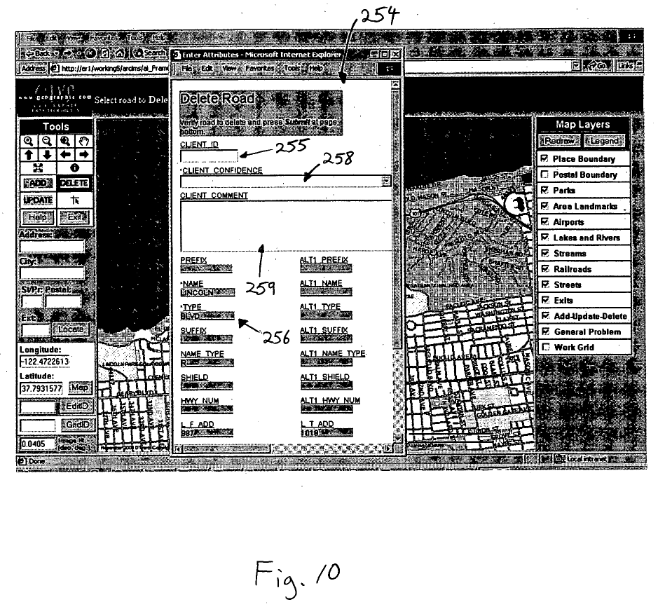

FIG. 9 shows the selection of the “Delete” button provided in the toolbar 210 which allows the user to request deletion of a road from the map that is displayed in the map window 204. In particular, upon selection of the “Delete” button from the toolbar 210, the user is provided with a cursor for allowing selection of the road to be deleted using a pointing device such as a mouse. In this regard, the selected road for deletion is shown highlighted in the circle 252 of FIG. 9. Upon selection of the road to be deleted, the “Delete Road” window 254 as shown in FIG. 10 is displayed to the user to allow generation of an enhancement request that requests the deletion of the selected road.

In the illustrated embodiment, the user may be required to enter a client identification number in the “Client ID” field 255 to ensure that the user is authorized to submit enhancement requests to delete roads. The name, prefix, and/or suffix, as well as the number and other various parameters of the selected road, are displayed in the corresponding fields generally indicated at 256 so that the user can confirm that the appropriate road was selected for deletion from the displayed map shown in the map window 204. The user indicates the confidence level by selecting an appropriate confidence entry from the “Client Confidence” drop down menu 258. The user can also type in comments to explain why the road should be deleted in the “Client Comment” field 259. A “Submit” button (not shown) is provided toward the bottom of the “Delete Road” window 240 to submit the generated enhancement request to the geospatial information system 10 for further processing.

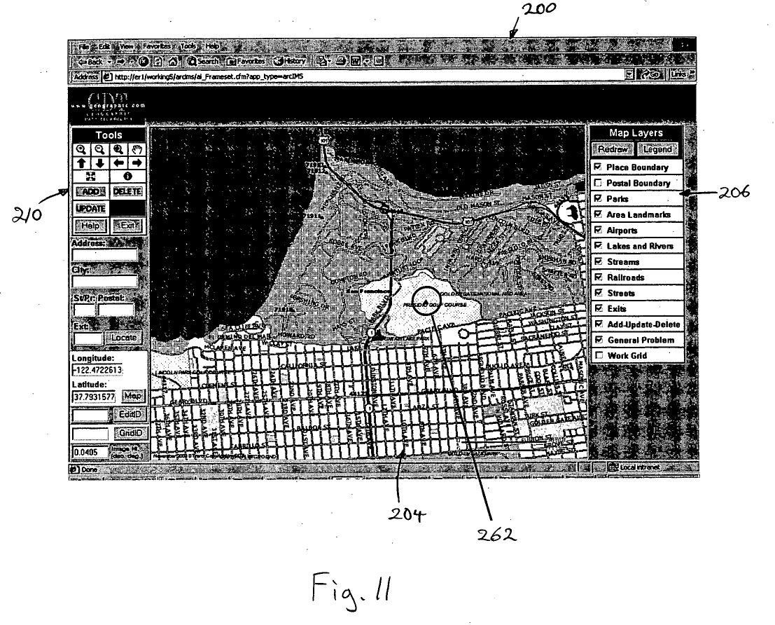

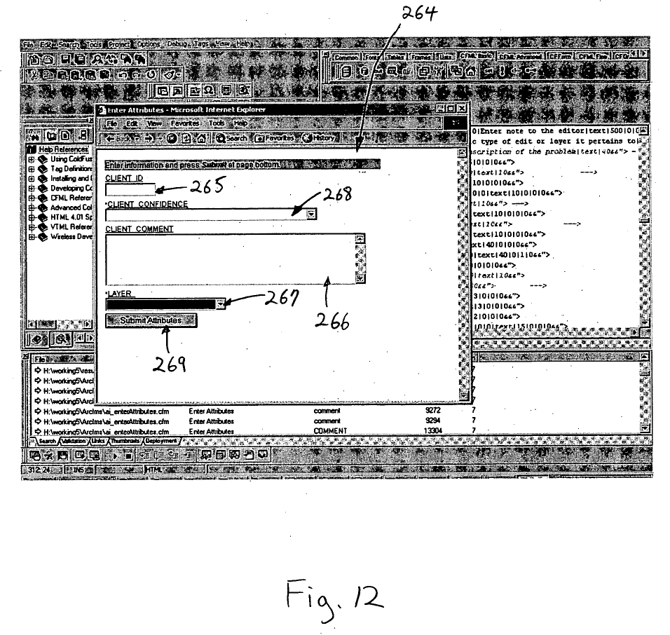

FIG. 11 shows the selection of the general problem point button in the toolbar 210 that is indicated by the intersection symbol “†” (best shown in FIG. 5). The selection of this button allows a user to identify a general problem point in the map displayed in the map window 204. Upon selection of the button, the user places a cursor of the pointing device (such as a mouse) at the particular location on the displayed map, and selects the location thereby providing a marker shown in the circle 262 to indicate the problem point. An attribute window 264 as shown in FIG. 12 is displayed to the user to allow generation of an enhancement request with respect to the identified location.

In particular, the user may be required to enter a client identification number in the “Client ID” field 265, and to enter comments that describe the problem with respect to the selected location in the “Client Comment” field 268. To facilitate proper identification of the problem point, a “Layer” drop down menu 267 may be provided to allow the user to identify the map layer which has the perceived error requiring change. As previously described, the layers may include landmarks, streets, etc. The user is requested to provide an indication as to the confidence level by selecting the appropriate selection from the “Client Confidence” drop down menu 268. By selecting the “Submit Attributes” button 269, the generated enhancement request is submitted to the geospatial information system 10 so that it can be further processed in the manner previously described above relative to FIG. 1.

In the above described manner, the present invention allows the user of the geospatial information system 10 to generate enhancement requests that set forth changes to geospatial information stored in the database 30. By allowing users to submit such enhancement requests, the geospatial information system 10 in accordance with the illustrated embodiment of the present invention allows the administrator of the system to maintain and update the database 30 with current geospatial information that is provided directly by the users of the geospatial information system 10 who will likely have the most current information. In addition, by providing a user an interface module 14 that allows the user to submit such changes by marking up a graphically displayed map, the geospatial information system 10 of the present embodiment greatly facilitates the generation and submission of enhancement requests for maintaining the accuracy of the information provided by the system.

In addition, as previously described relative to FIG. 1, the geospatial information system 10 in accordance with the illustrated embodiment, is implemented with a monitoring module 18 that dynamically monitors the status of the enhancement request and/or the change requested in the enhancement request. As noted, the monitoring module 18 is also adapted to graphically indicate the status of the enhancement request and/or change requested on the graphic map that is displayed on the map window 204 of the user interface screen 200. This may be attained by rendering the roads for which change was requested using a plurality of colors, each color representing a different status of the enhancement request and/or the requested change of the enhancement requests. In this regard, when a user logs into the user interface screen 200, the geospatial information system 10 of the present embodiment is adapted to display the geographical area for which enhancement requests were submitted by the user during prior login sessions of the geospatial information system 10.

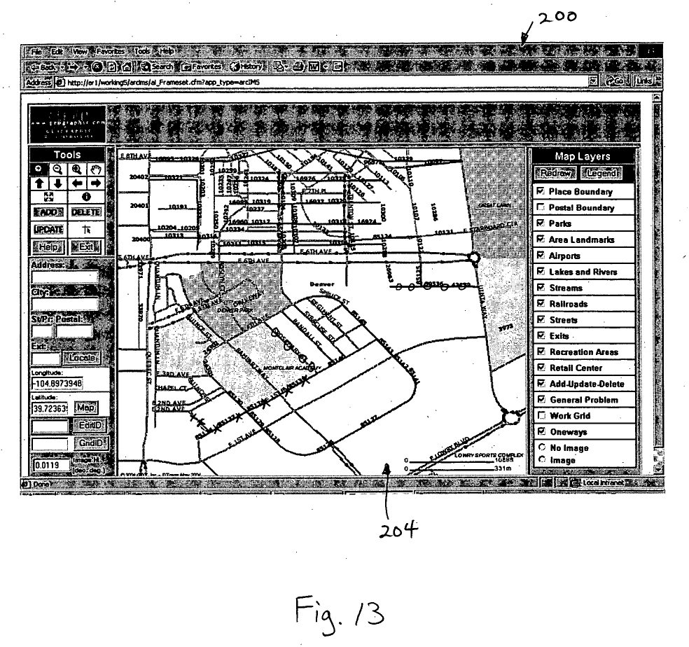

An example graphic map displayed in the map window 204 of the user interface screen 200 is shown in FIG. 13. The roads for which there are pending changes that have been requested by the user in previously submitted enhancement requests are displayed in one color (in the illustration, marked by series of “x”). The roads for which the changes have been approved and incorporated into the database 30 of the geospatial information system 10 are displayed in a different color (in the illustration, marked by series of “o”). Of course, additional colors may be used to represent that a change requested for the particular road has a particular status. For example, another color may indicate that the enhancement request requires confirmation, for example, by field technicians, to ensure accuracy of the requested change. In this manner, the geospatial information system 10 in accordance with the described embodiment of the present invention significantly facilitates monitoring the status of the enhancement requests that are submitted by the user of the geospatial information system 10.

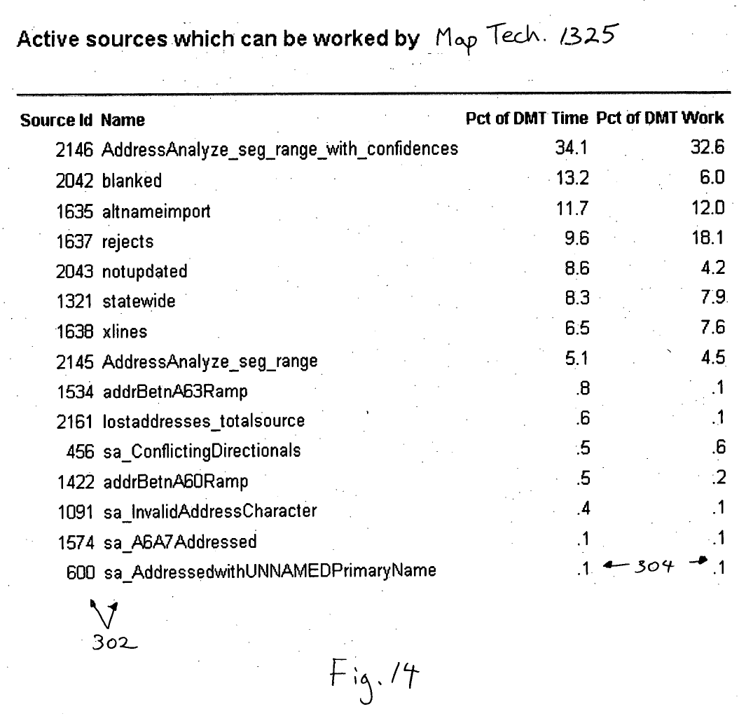

As noted with respect to the embodiment of the geospatial information system 10 shown in FIG. 1, the workflow management module 22 ensures that the generated enhancement requests are assigned to, and are processed by, map technicians having the requisite qualifications and skills required to efficiently, and accurately process the changes requested. In this regard, FIG. 14 illustrates an example entry in the listing database 34 of the geospatial information system 10 shown in FIG. 1 for one particular map technician. As shown, FIG. 14 lists the types of enhancement requests or changes to the geospatial information that can be processed by the map technician 1325 in columns 302, both by a source ID, and an abbreviated name. In addition, the percentage of time and work as well as other statistics associated with each of the identified types of changes are also provided in columns 304 for the particular map technician so as to allow the workflow management module 22 to ascertain the skills and experience of the particular map technician for the listed types of changes. Such information can further be utilized by the workflow management module 22 to assign each of the submitted enhancement requests to an appropriate map technician in the manner previously described above. Of course, the example entry as shown in FIG. 14 is merely one example and the present invention is not limited thereto.

As also noted previously, the workflow management module 22 may further be adapted to display a corresponding map tile 320, an example of which is shown in FIG. 14, to expedite processing of the enhancement request. A map tile 320 graphically renders the geospatial information/data that is stored in the database 30, each tile showing a small portion of a particular geographical location. The map tiles also allow actual editing and modification to the geospatial information by authorized map technicians that administer the geospatial information system 10. Thus, when a map technician selects the assigned enhancement request to work on, the workflow management module 22 of the illustrated embodiment automatically retrieves the appropriate map tile 320 from the database 30, and displays it to the map technician so that the map technician can readily implement the requested change as set forth in the enhancement request. In addition, the workflow management module 22 further shows on the map tile 320 displayed, the change that is requested by the enhancement request, as indicated by “x edit type” in the example displayed map tile 320 of FIG. 14. This allows the map technician to quickly determine the nature of the requested edit and allows the request to be rapidly processed. Thus, the workflow management module 22 of the described embodiment further facilitates efficient processing of the enhancement requests that are submitted by the users of the geospatial information system 10.

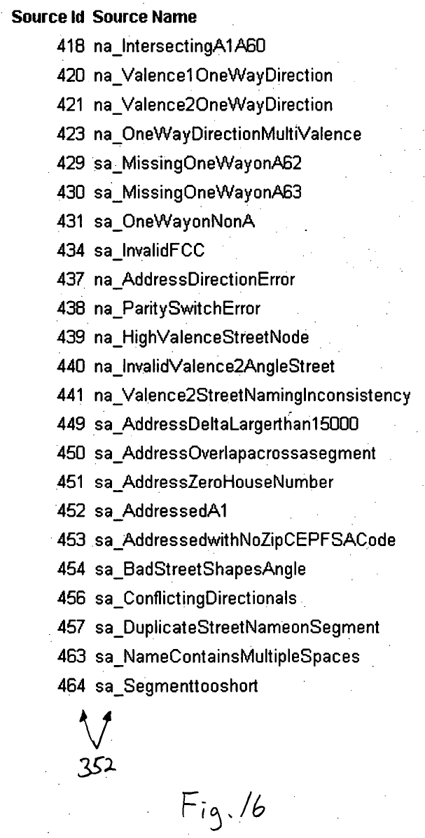

Finally, as also noted with respect to FIG. 1, the audit module 20 of the geospatial information system 10 is adapted to check the quality of the requested change set forth in the submitted enhancement requests. As described, the audit module 20 of the geospatial information system 10 applies one or more logic checks to determine whether the change requested in the enhancement request is consistent with other confirmed geospatial information that are stored in the database 30. Example logic checks with respect to various types of changes have been discussed in detail above relative to the audit module 20 shown in FIG. 1. FIG. 16 illustrates a sampling of numerous logic checks that may be implemented by the audit module 20 to ensure that the change requested in the enhancement request is consistent with other confirmed geospatial information stored in the database 30. In this regard, the ID number and the name of the logic check is provided in columns 352, the names listed being indicative of the function of the particular logic check. Of course, it should be understood that the logic checks set forth in the sampling of FIG. 16 are merely provided as examples of logic checks that may be performed, and in other implementation of the present invention, the audit module 20 may be adapted to conduct different logic checks.

In view of the foregoing, it should be evident to one of ordinary skill in the art how the present invention provides a geospatial information system that allows users of the system to convey more accurate geospatial information. In addition, it should also be evident that the present invention provides a geospatial information system which greatly facilitates updating of geospatial information so that such updates can be effectuated in a cost effective and efficient manner. Moreover, it should further be evident to one of ordinary skill in the art that the present invention further provides an efficient method for updating geospatial information. Finally, it should further be evident that the system and method as described above can be implemented in a computer readable media.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

1. A geospatial information system comprising:
a database adapted to store geospatial information;
a processing unit in electronic communication with said database, said processing unit being adapted to access and retrieve said geospatial information from said database;
a tool permissions module to associate a tool permission level with a user; and
a user interface module including a plurality of enhancement tools to allow a user to generate an enhancement request that requests a change to said geospatial information stored in said database, each of said plurality of enhancement tools being adapted to request a specific type of change to said geospatial information stored in said database, and being generated based on said tool permission level associated with the user so that the user is provided with a plurality of tools corresponding to said tool permission level.

2. The system of claim 1, wherein said geospatial information is at least one of an address, street name, street direction, intersection, and street path.

3. The system of claim 1, wherein said tool permission level associated with the user is determined based on a login identification assigned to the user.

4. The system of claim 1, further including a monitoring module adapted to dynamically monitor a status of at least one of said enhancement request and said change requested in said enhancement request, and to graphically indicate the status in a graphical map using a plurality of colors, each color indicating a different status.

5. The system of claim 1, further including an audit module adapted to apply at least one logic check to determine whether said change requested in said enhancement request is consistent with other confirmed geospatial information stored in said database.

6. The system of claim 1, further including a workflow management module adapted to automatically select a technician for processing said enhancement request from a list of plurality of technicians based on at least said change requested and qualifications of said technician.

7. The system of claim 1, wherein said user interface module is adapted to allow generation of a plurality of enhancement requests, and said system further includes a prioritization module adapted to sequence the order in which said plurality of enhancement requests are processed.

8. The system of claim 1, further including an update module adapted to update said geospatial information stored in said database based on at least said enhancement request submitted by the user, and to deliver said updated geospatial information to the user.

9. A geospatial information system comprising:
a database adapted to store geospatial information;
a processing unit in electronic communication with said database, said processing unit being adapted to access and retrieve said geospatial information from said database;
a user interface module adapted to display a graphical map, and includes an enhancement tool to allow a user to generate an enhancement request that requests a change to said geospatial information stored in said database by marking changes on said graphical map; and
a monitoring module adapted to dynamically monitor a status of at least one of said enhancement request and said change requested in said enhancement request, and to graphically indicate the status in said graphical map using a plurality of colors that represent different status.

10. The system of claim 9, further including an audit module adapted to apply at least one logic check for determining whether said change requested in said enhancement request is consistent with other confirmed geospatial information stored in said database.

11. The system of claim 9, further including a workflow management module adapted to automatically select a technician for processing said enhancement request from a list of plurality of technicians based on at least said change requested and qualifications of said technician.

12. The system of claim 9, wherein said user interface module is adapted to allow generation of a plurality of enhancement requests, and said system further includes a prioritization module adapted to sequence the order in which said plurality of enhancement requests are processed.

13. A geospatial information system comprising:
a database adapted to store geospatial information;
a processing unit in electronic communication with said database, said processing unit being adapted to access and retrieve said geospatial information from said database;
a user interface module including an enhancement tool to allow a user to generate an enhancement request that request a change to said geospatial information stored in said database; and
an audit module adapted to apply at least one logic check to determine whether said change requested in said enhancement request is consistent with other confirmed geospatial information stored in said database, and to generate an edit failure notification to the user if said change requested in said enhancement request is inconsistent with said other confirmed geospatial information stored in said database.

14. The system of claim 13, further including a workflow management module adapted to automatically select a technician for processing said enhancement request from a list of plurality of technicians based on at least said change requested and qualifications of said technician.

15. The system of claim 13, wherein said user interface module is adapted to allow generation of a plurality of enhancement requests, and said system further includes a prioritization module adapted to sequence the order in which said plurality of enhancement requests are processed.

16. A geospatial information system comprising:
a database adapted to store geospatial information;
a processing unit in electronic communication with said database, said processing unit being adapted to access and retrieve said geospatial information from said database;
a user interface module including an enhancement tool to allow a user to generate an enhancement request that requests a change to said geospatial information stored in said database; and
a workflow management module adapted to automatically select a technician for processing said enhancement request from a list of plurality of technicians based at least on said change requested in said enhancement request and qualifications of said technician.

17. The system of claim 16, wherein said workflow management module automatically retrieves a graphical tile from said database that graphically illustrates a geographical area for which change is requested in said enhancement request.

18. The system of claim 16, wherein said user interface module is adapted to allow generation of a plurality of enhancement requests, and said system further includes a prioritization module adapted to sequence the order in which said plurality of enhancement requests are processed.

19. A method for updating geospatial information comprising the steps of:
providing a database adapted to store geospatial information;
accessing said database to retrieve said geospatial information from said database;
associating a tool permission level to a user; and
generating a customized interface including a plurality of enhancement tools to allow the user to request changes to said geospatial information stored in said database, each of said plurality of enhancement tools being adapted to request a specific type of change to said geospatial information stored in said database, and being generated based on said tool permission level associated with the user.

20. The method of claim 19, wherein said geospatial information is at least one of an address, street name, street direction, intersection, and street path.

21. The method of claim 19, wherein said tool permission level associated with the user is based on a login identification of the user.

22. The method of claim 19, further including the steps of monitoring a status of said requested change, and graphically displaying the status in an electronic graphical map using a plurality of colors, each color indicating a different status.

23. The method of claim 19, further including the step of applying at least one logic check to determine whether said requested change is consistent with other confirmed geospatial information stored in said database.

24. The method of claim 19, further including the step of automatically selecting a technician for processing said requested change from a list of plurality of technicians based on said requested change and qualifications of said technician.

25. The method of claim 19, wherein said at least one change is a plurality of changes, and further including the step of electronically prioritizing the order in which said changes are processed.

26. The method of claim 19, further including the step of updating said geospatial information stored in said database based on at least said requested change.

27. A method for updating geospatial information comprising the steps of:
providing a database adapted to store geospatial information;
accessing said database to retrieve said geospatial information from said database;
generating and displaying an electronic graphical map based on said geospatial information retrieved from said database;
requesting a change to said geospatial information stored in said database by marking said change on said displayed electronic graphical map;
monitoring a status of said requested change; and
automatically indicating the status of said requested change in said displayed electronic graphical map using colors that each represent a particular status of said requested change.

28. The method of claim 27, further including the step of applying at least one logic check to determine whether said change requested is consistent with other confirmed geospatial information stored in said database.

29. The method of claim 27, further including the step of automatically selecting a technician for processing said enhancement request from a list of plurality of technicians based on said change requested and qualifications of said technician.

30. The method of claim 27, further including the steps of requesting a plurality of changes to said geospatial information, and electronically prioritizing the order in which said changes are processed.

31. A method for updating geospatial information comprising the steps of:
providing a database adapted to store geospatial information;
accessing said database to retrieve said geospatial information from said database;
displaying an electronic graphical map based on said geospatial information retrieved from said database;
requesting a change to said geospatial information stored in said database by marking said change on said displayed electronic graphical map; and
applying at least one logic check to determine whether said change requested is consistent with other confirmed geospatial information stored in said database.

32. The method of claim 31, further including the step of automatically selecting a technician for processing said requested change from a list of plurality of technicians based on said change requested and qualifications of said technician.

33. The method of claim 31, further including the steps of requesting a plurality of changes to said geospatial information, and electronically prioritizing the order in which said changes are processed.

34. A method for updating geospatial information comprising the steps of:
providing a database adapted to store geospatial information;
accessing said database to retrieve said geospatial information from said database;
displaying an electronic graphical map based on said geospatial information retrieved from said database;
requesting a change to said geospatial information stored in said database by marking said change on said displayed electronic graphical map; and
automatically selecting a technician for processing said enhancement request from a list of plurality of technicians based on said change requested and qualifications of said technician.

35. The method of claim 34, further including the steps of requesting a plurality of changes to said geospatial information, and electronically prioritizing the order in which said changes are processed.

36. A method for updating geospatial information comprising the steps of: providing a database adapted to store geospatial information;
accessing said database to retrieve said geospatial information from said database;
displaying an electronic graphical map based on said geospatial information retrieved from said database;
requesting a plurality of changes to said geospatial information stored in said database by marking said changes on said displayed electronic graphical map; and
electronically prioritizing the order in which said changes are processed.
